(19) United States
(12) Patent Application Publication
(10) Pub. No.: US 2022/0185143 A1
(43) Pub. Date: Jun. 16, 2022

(54) BATTERY MANAGEMENT SYSTEM, BATTERY MANAGEMENT METHOD, AND TERMINAL DEVICE

(71) Applicant: PANASONIC INTELLECTUAL PROPERTY MANAGEMENT CO., LTD., Osaka (JP)

(72) Inventors: Masashi TAKEMURA, Kanagawa (JP); Toshiya ZAITSU, Tokyo (JP); Hiroki SHINOHARA, Kanagawa (JP); Kenichiro SHIBASAKI, Kanagawa (JP); Koji AOTO, Hyogo (JP); Ryota SAITO, Kanagawa (JP)

(73) Assignee: PANASONIC INTELLECTUAL PROPERTY MANAGEMENT CO., LTD., Osaka (JP)

(21) Appl. No.: 17/436,443

(22) PCT Filed: Jan. 22, 2020
(86) PCT No.: PCT/JP2020/002186

§ 371 Date: Sep. 3, 2021

(30) Foreign Application Priority Data
Mar. 6, 2019 (JP) 2019-040798

(51) Int. Cl. B60L 53/68; G06Q 30/06; B60L 53/80; H01M 10/42

(52) U.S. Cl. CPC B60L 53/68; G06Q 30/0639; H01M 2010/4278; H01M 10/425; H01M 2010/4271; B60L 53/80

(57) ABSTRACT

To enable a user to easily grasp an operation state of a battery station in an area desired by the user regardless of the current position of the user, a user terminal is configured to display a guidance screen for guiding a location of the battery station to the user based on information transmitted from a management server, and the guidance screen displays a guide map showing an icon 92 indicating a location of the battery station and superimposed on a map 91 of a designated area designated by the user such that whether an opening period of the battery station is new or old can be identified.

### TECHNICAL FIELD

The present invention relates to a battery exchange service which enables users of electric vehicles or the like to exchange battery devices at battery stations, and more particularly, to a battery management system and a battery management method for managing the battery stations and the battery devices and to a terminal device carried by each user.

### BACKGROUND ART

In recent years, electric vehicles such as electric motorcycles have attracted attention from the viewpoint of solving the problems of air pollution due to exhaust gas and high fuel costs. The cruising ranges of such electric vehicles are progressively extended owing to the improvement in the performance of battery devices, but such electric vehicles may cause inconvenience since they cannot travel continuously for a long time due to the necessity for charging the battery devices.

In order to eliminate such inconvenience, there is a conventional battery exchange service that enables the electric vehicles to travel continuously for a long time by fitting the electric vehicles with detachable battery devices so that exhausted battery devices can be exchanged with fully charged battery devices at battery stations (see Patent Document 1).

### PRIOR ART DOCUMENT(S)

### Patent Document(s)

Patent Document 1: JP2014-529118A

### SUMMARY OF THE INVENTION

### Task to be Accomplished by the Invention

The above conventional technique acquires the current position of a user by GPS (Global Positioning System), guides the user through the location of the battery station located near the user based on the current position of the user, and provides the user with information on the availability of the battery devices at the battery station, more specifically, information on the operation state such as whether the battery devices can be exchanged at the battery station and how many battery devices can be exchanged thereat.

The above conventional technique only guides the user through the location of the battery station near the user based on the current position of the user, but such guidance is not sufficient as guidance on the battery station. For example, the user may have a desire to confirm the location of the battery station on the way to a distant destination. However, the conventional technique does not give any consideration to such a desire, and thus there is a problem that the user cannot easily grasp an operation state of a battery station in an area desired by the user.

In view of such a problem of the prior art, a primary object of the present invention is to provide a battery management system, a battery management method, and a terminal device that enable a user to easily grasp an operation state of a battery station in an area desired by the user regardless of the current position of the user.

### Means to Accomplish the Task

The present invention provides a battery management system including a plurality of battery exchange devices located in respective battery stations and configured to store and charge battery devices returned by users and to rent the charged battery devices to the users in exchange for the returned battery devices; a server device connected to the battery exchange devices via a network and configured to manage exchanging states of the battery devices at the battery exchange devices; and a terminal device carried by each user and connected to the server device via the network; wherein the server device is configured to acquire map information on a designated area according to an operation on the terminal device by the user, acquire operation state information on an opening period of each battery station located in the designated area, and display a guide map on the terminal device based on the map information and the operation state information, the guide map showing a fixed pattern image indicating a location of the battery station and superimposed on a map of the designated area such that whether the opening period of the battery station is new or old can be identified.

The present invention further provides a battery management method used by a server device for managing battery stations where users exchange battery devices and for managing the battery devices, the battery management method including: acquiring map information on a designated area according to an operation on a terminal device carried by each user, acquiring operation state information on an opening period of each battery station located in the designated area, and displaying a guide map on the terminal device based on the map information and the operation state information, the guide map showing a fixed pattern image indicating a location of the battery station and superimposed on a map of the designated area such that whether the opening period of the battery station is new or old can be identified.

The present invention further provides a terminal device carried by a user and connected to a server device via a network, wherein the terminal device is configured to display a guidance screen for guiding a location of a battery station to the user based on information transmitted from the server device, and the guidance screen includes a guide map showing a fixed pattern image indicating a location of the battery station and superimposed on a map of a designated area designated by the user such that whether an opening period of the battery station is new or old can be identified.

### Effect of the Invention

According to the present invention, the guide map can guide a user through the location of the battery station in an area desired by the user. Furthermore, the fixed pattern image can guide the user through an opening state of the battery station. Accordingly, the user can easily grasp the operation state of the battery station in the area desired by the user regardless of the current position of the user.

### BRIEF DESCRIPTION OF THE DRAWING(S)

FIG. 1 is an overall schematic diagram of a battery sharing system according to an embodiment;

FIG. 2 is a block diagram showing schematic configurations of a battery exchanger 3, a management server 4, and a user terminal 5;

FIGS. 3A and 3B are explanatory diagrams showing registered contents of a fixed pattern map management table and a battery station management table used by the management server 4;

FIG. 4 is an explanatory diagram showing a login screen displayed on the user terminal 5;

FIG. 5 is an explanatory diagram showing a search screen displayed on the user terminal 5;

FIG. 6 is an explanatory diagram showing a station guidance screen displayed on the user terminal 5;

FIGS. 7A to 7C are explanatory diagrams each showing a transition state of each icon 92 of a battery station on the station guidance screen;

FIG. 8 is an explanatory diagram showing a notification list screen displayed on the user terminal 5;

FIG. 9 is an explanatory diagram showing a detailed notification screen displayed on the user terminal 5; and

FIG. 10 is a sequence diagram showing operation procedures of the user terminal 5 and the management server 4 when battery station information is provided.

### DESCRIPTION OF THE PREFERRED EMBODIMENT(S)

To achieve such an object, the first aspect of the present invention provides a battery management system including: a plurality of battery exchange devices located in respective battery stations and configured to store and charge battery devices returned by users and to rent the charged battery devices to the users in exchange for the returned battery devices; a server device connected to the battery exchange devices via a network and configured to manage exchanging states of the battery devices at the battery exchange devices; and a terminal device carried by each user and connected to the server device via the network; wherein the server device is configured to acquire map information on a designated area according to an operation on the terminal device by the user, acquire operation state information on an opening period of each battery station located in the designated area, and display a guide map on the terminal device based on the map information and the operation state information, the guide map showing a fixed pattern image indicating a location of the battery station and superimposed on a map of the designated area such that whether the opening period of the battery station is new or old can be identified.

According to this aspect, the guide map can guide a user through the location of the battery station in an area desired by the user. Furthermore, the fixed pattern image can guide the user through an opening state of the battery station. Accordingly, the user can easily grasp the operation state of the battery station in the area desired by the user regardless of the current position of the user.

According to the second aspect of the present invention, the server device is configured to store the operation state information on the respective battery stations, and select the operation state information on the battery station located in the designated area based on location information on the respective battery stations.

According to this aspect, the user can be appropriately guided through the operation state of the battery station.

According to the third aspect of the present invention, the server device is configured to acquire information on a designated date and time according to the operation on the terminal device by the user, and display the fixed pattern image in a display mode corresponding to an opening state of the battery station at the designated date and time.

According to this aspect, the user can be guided through the operation state of the battery station based on the date and time designated by the user. Accordingly, appropriate guidance according to the using schedule of the user can be provided.

According to the fourth aspect of the present invention, the server device is configured to change the display mode of the fixed pattern image in a case where a difference between the opening period of the battery station and the designated date and time is within a prescribed period.

According to this aspect, the user can be guided through a recently opened battery station and a forthcoming battery station.

According to the fifth aspect of the present invention, a change in the display mode of the fixed pattern image includes at least one of a change in a display color of the fixed pattern image, blinking of a part or an entirety of the fixed pattern image, addition of characters to the fixed pattern image, and addition of a graphic image to the fixed pattern image.

According to this aspect, the user can immediately grasp a recently opened battery station and a forthcoming battery station.

The sixth aspect of the present invention provides a battery management method used by a server device for managing battery stations where users exchange battery devices and for managing the battery devices, the battery management method including: acquiring map information on a designated area according to an operation on a terminal device carried by each user, acquiring operation state information on an opening period of each battery station located in the designated area, and displaying a guide map on the terminal device based on the map information and the operation state information, the guide map showing a fixed pattern image indicating a location of the battery station and superimposed on a map of the designated area such that whether the opening period of the battery station is new or old can be identified.

According to this aspect, like the first aspect of the present invention, the user can easily grasp the operation state of the battery station in the area desired by the user regardless of the current position of the user.

The seventh aspect of the present invention provides a terminal device carried by a user and connected to a server device via a network, wherein the terminal device is configured to display a guidance screen for guiding a location of a battery station to the user based on information transmitted from the server device, and the guidance screen includes a guide map showing a fixed pattern image indicating a location of the battery station and superimposed on a map of a designated area designated by the user such that whether an opening period of the battery station is new or old can be identified.

According to this aspect, like the first aspect of the present invention, the user can easily grasp the operation state of the battery station in the area desired by the user regardless of the current position of the user.

In the following, an embodiment of the present invention will be described with reference to the appended drawings.

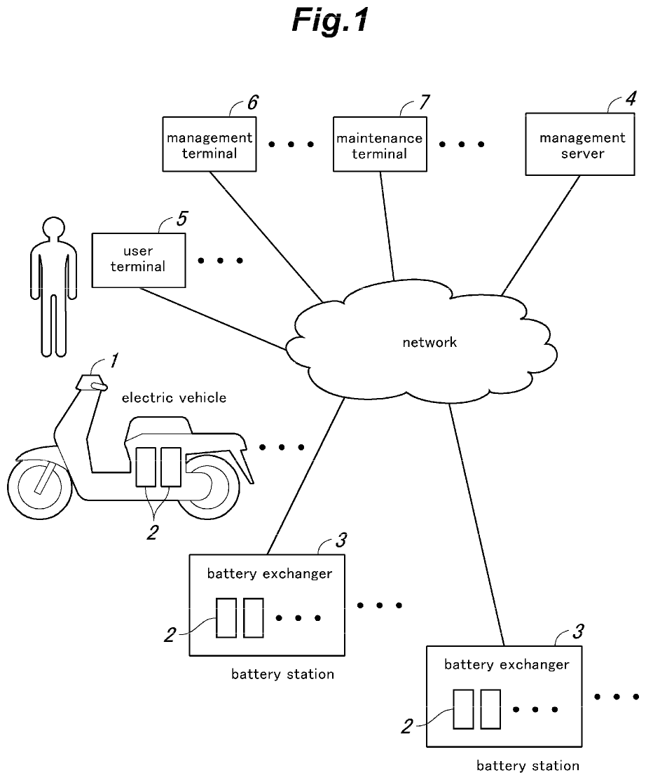

FIG. 1 is an overall schematic diagram of a battery sharing system according to an embodiment of the present invention.

This battery sharing system is configured to provide a service (battery exchange service) in which battery packs 2 (battery devices) fitted to electric vehicles 1 such as electric motorcycles can be shared among a plurality of users, and includes battery exchangers 3 (battery exchange devices), a management server 4 (server device), user terminals 5 (terminal devices), management terminals 6, and maintenance terminals 7.

The battery exchangers 3, the management server 4, the user terminals 5, the management terminals 6, and the maintenance terminals 7 are connected via a network such as the Internet. The battery exchangers 3 and the user terminals 5 are connected to the network via a wireless communication such as a mobile communication network and a wireless LAN.

Each electric vehicle 1 is fitted with the battery packs 2, and travels on the electric power of the battery packs 2. The electric vehicle 1 consists of an electric motorcycle in the example shown in FIG. 1, but may also consist of a four-wheeled vehicle. Further, the electric vehicle 1 may be a mobility device not designed for public roads such as an electric wheelchair, an electric cart, or a riding cart for use in a theme park, a golf course, or the like.

Each battery exchanger 3 stores and charges the battery packs 2 returned by the users, and rent the charged battery packs 2 to the users in exchange for the returned battery packs 2. The battery exchangers 3 are installed in battery stations attached to facilities (stores) such as convenience stores and gas stations. A plurality of battery exchangers 3 are installed in each one of the battery stations.

The management server 4 registers, as users (members), persons subscribing to the battery exchange service so as to use the battery packs 2, and manages the battery packs 2 in association with the users to whom the battery packs 2 are rented. Also, the management server 4 manages the exchanging states of the battery packs 2 in each battery exchanger 3. Also, the management server 4 monitors the state of each battery exchanger 3 (whether each battery exchanger 3 is online) and the states of the battery packs 2 stored in the battery exchanger 3 (whether the battery packs 2 are fully charged), and transmits the state information on the battery exchanger 3 and the battery packs 2 to the management terminals 6 and the maintenance terminals 7. Further, the management server 4 transmits information on an operation state of each battery station and the like to the user terminals 5.

Each user terminal 5 consists of a smartphone, a tablet terminal, or the like, and is carried by the user of the electric vehicle 1. The user terminal 5 displays various screens based on the information transmitted from the management server 4. By using these screens, the user terminal 5 guides the user through the position and operation state of each battery station, and enables the user to make a battery exchange reservation.

Each management terminal 6 is installed in a facility to receive the users such as a management center, and is operated by an administrator. On the management terminal 6, the administrator can perform an operation for user registration. Also, on the management terminal 6, the administrator can check the information transmitted from the management server 4.

Each maintenance terminal 7 is installed in a facility dedicated for a maintenance operation or a facility such as a store provided with the battery station, and is operated by a maintenance person. On the maintenance terminal 7, the maintenance person can check the information transmitted from the management server 4.

The battery packs 2 to be fitted to electric vehicles 1 are given as an example in the present embodiment, but battery devices to which the battery packs 2 are fitted are not limited to the electric vehicles 1, and may be portable power supply devices, for example.

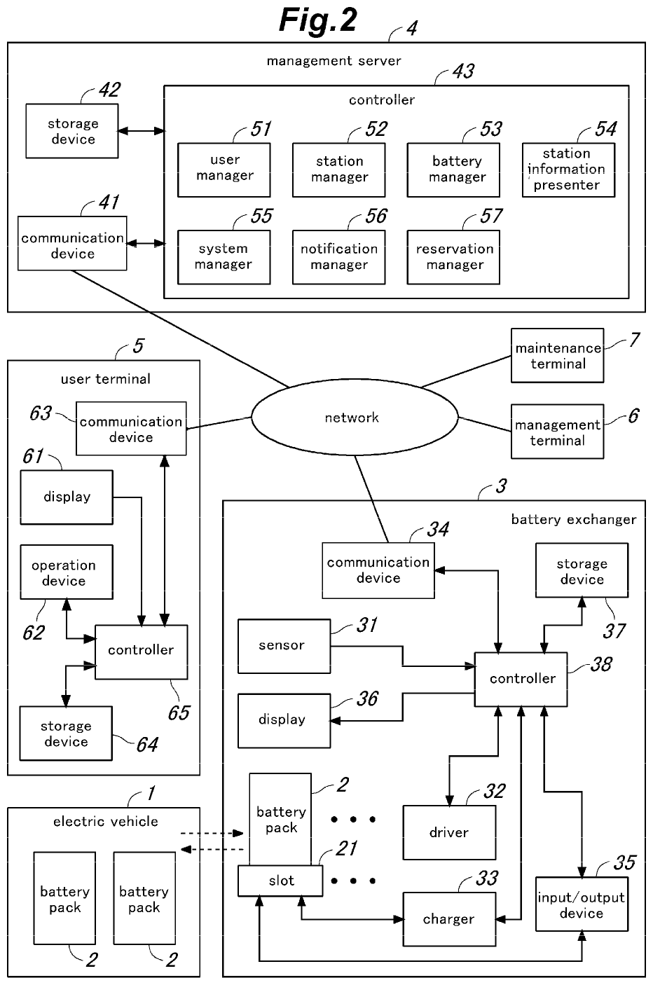

Next, schematic configurations of each battery exchanger 3, the management server 4, and each user terminal 5 will be described. FIG. 2 is a block diagram showing the schematic configurations of the battery exchanger 3, the management server 4, and the user terminal 5.

Each battery exchanger 3 includes a sensor 31, a driver 32, a charger 33, a communication device 34, an input/output device 35, a display 36, a storage device 37, and a controller 38.

The sensor 31 consists of a human sensor, for example, and detects a person who visits the battery exchanger 3 for battery exchange.

Incidentally, the battery exchanger 3 may perform user authentication to identify the user who visits the battery exchanger 3 for the battery exchange. In this case, the battery exchanger 3 may identify the user by face recognition based on an image captured by a camera. Also, the battery exchanger 3 may identify the user by communicating with an RFID (radio frequency identifier) tag or a non-contact type IC card carried by the user, or by communicating with each user terminal 5 equipped with an NFC (Near Field Communication) function. Further, the battery exchanger 3 may detect that the user is about to return each battery pack 2 by reading a two-dimensional code affixed to the battery pack 2 based on the image captured by the camera.

In response to an instruction from the controller 38, the driver 32 drives, upon return or rental of the battery packs 2, an opening/closing mechanism of an opening/closing door and a storing/dispensing mechanism for storing the returned battery packs 2 and dispensing the battery packs 2 to be rented to the users.

The charger 33 charges the battery packs 2 via slots 21 (trays).

The communication device 34 communicates with the management server 4 via the network.

The input/output device 35 transmits and receives information to and from the battery packs 2. For example, the serial numbers, alerts, deterioration information on the battery packs 2 are received from the battery packs 2.

The display 36 displays a guidance screen for giving user guidance on exchange of the battery packs 2.

The storage device 37 stores programs and the like to be executed by the processor that constitutes the controller 38.

The controller 38 consists of a processor, and controls various parts of each battery exchanger 3. For example, the controller 38 controls the exchange of the battery packs 2. Namely, the controller 38 controls the driver 32 to cause the driver 32 to perform an operation for storing the battery packs 2 returned by the users and an operation to rent the charged battery packs 2 to the users. More specifically, when the sensor 31 detects each user, the controller 38 causes the driver 32 to start a battery exchange operation and thus to open the opening/closing door, thereby making the user return the battery packs 2.

Further, the controller 38 monitors the charging states and empty states of the battery packs 2 attached to the respective slots 21, and reports information thereon to the management server 4. Accordingly, the management server 4 can manage the charging states and empty states of the battery packs 2 in the battery exchanger 3.

The electric vehicle 1 is fitted with one or more battery packs 2. Further, the battery exchanger 3 stores a plurality of (for example, 8) battery packs 2. In a case where the electric vehicle 1 is fitted with a plurality of battery packs 2, the battery exchanger 3 exchanges the plurality of battery packs 2 at the same time. In the examples shown in FIGS. 1 and 2, the number of battery packs 2 fitted to the electric vehicle 1 is set to two, but the number of battery packs 2 may be one, or three or more.

The management server 4 includes a communication device 41, a storage device 42, and a controller 43.

The communication device 41 communicates with each battery exchanger 3, each user terminal 5, each management terminal 6, and each maintenance terminal 7 via the network.

The storage device 42 stores programs to be executed by the processor that constitutes the controller 43. Also, the storage device 42 stores management information such as user registration information, associating information that associates the battery packs 2 with the users to whom the battery packs 2 are rented. Also, the storage device 42 stores information on an opening period, a closing period, and a maintenance suspension period for each battery station. Also, the storage device 42 stores information on an area map (a fixed pattern map) generated in advance for each of sub-areas included in a service target area.

The controller 43 includes a user manager 51, a station manager 52, a battery manager 53, a station information presenter 54, a system manager 55, a notification manager 56, and a reservation manager 57. The controller 43 consists of a processor, and the processor executes the programs stored in the storage device 42 to realize various components of the controller 43.

The user manager 51 manages the users who use the battery packs 2. For example, the administrator accepts applications for new registration from the users, and registers user information (user IDs, names, addresses, and vehicle types of electric vehicles 1 to be used) by operating each management terminal 6 (user registration).

The station manager 52 manages each battery station and each battery exchanger 3 installed therein. More specifically, the station manager 52 manages the information, which is input by the administrator, about the opening, closing, and maintenance suspension (temporary suspension due to maintenance work) of the battery station. Also, the station manager 52 collects from the battery exchanger 3 the information on the state (online state or the like) of the battery exchanger 3 located in the battery station, and manages the collected information. Further, the station manager 52 collects from the battery exchanger 3 information on the state (charged state, empty state, or the like) of the battery packs 2 stored in the battery exchanger 3, and manages the collected information.

The battery manager 53 manages the battery packs 2 stored in each battery exchanger 3 and the battery packs 2 that are being rented to the users.

The station information presenter 54 presents the information on the battery stations to the users. For example, the station information presenter 54 generates information on a station guidance screen for guiding each user through the battery stations, and transmits this information to each user terminal 5, thereby causing the user terminal 5 to display the station guidance screen. This station guidance screen guides the locations of the battery stations and the number of battery packs 2 that can be exchanged at each battery station. Further, in the present embodiment, the station guidance screen guides the operation state of each battery station, more specifically, the state of the opening, closing and maintenance suspension thereof.

At this time, based on the management information on a battery configuration of the electric vehicle 1 used by each user, the station information presenter 54 searches for battery stations suitable for the battery configuration of the user, and displays the suitable battery stations on the station guidance screen. The above battery configuration means the number of battery packs 2 fitted to the electric vehicle 1, and battery stations with fully charged battery packs 2 equal to or more than the battery packs fitted to the electric vehicle 1 are extracted and displayed on the station guidance screen.

Incidentally, the user registration information as the management information includes a vehicle model of the electric vehicle 1 used by each user, and the battery configuration of the user can be acquired from the vehicle model of the electric vehicle 1. In particular, the battery configuration of the user can be acquired based on the user ID acquired at the time of login.

Also, in the present embodiment, the battery packs 2 of only one type are used in the battery exchange service, and thus the battery configuration of the electric vehicle 1 means the number of battery packs 2 fitted to the electric vehicle 1. However, the battery packs 2 of plural types may be used in the battery exchange service. In such a case, the battery configuration includes not only the number of the battery packs 2 fitted to the electric vehicle 1 but also the types of the battery packs 2.

The system manager 55 monitors the status of the system, and presents the status of the system to the administrator and the maintenance person. For example, the system manager 55 generates a management screen to display the status of the system and transmits the management screen to each management terminal 6 and each maintenance terminal 7, thereby causing the management terminal 6 and the maintenance terminal 7 to display the management screen. Accordingly, the administrator and the maintenance person can check the status of the system.

The notification manager 56 manages notifications (notices) to each user. More specifically, the notification manager 56 transmits to each user terminal 5 guidance on the opening and closing of each battery station, guidance on maintenance work to be performed at the battery station, and guidance that battery exchange reservation cannot be made at the battery station due to a network failure or the like. Incidentally, the content of each notification is input by the administrator. At this time, the administrator inputs digest information and detailed information on each of notification items.

The reservation manager 57 manages the battery exchange reservation by each user. More specifically, the reservation manager 57 accepts the battery exchange reservation when the user performs a reservation operation on the user terminal 5. Also, the reservation manager 57 cancels the battery exchange reservation when the user performs a cancellation operation of the battery exchange reservation on the user terminal 5. Also, if the battery exchange is not performed within a prescribed period after acceptance of the battery exchange reservation, the reservation manager 57 forcibly cancels the battery exchange reservation.

Each user terminal 5 includes a display 61, an operation device 62, a communication device 63, a storage device 64, and a controller 65.

The display 61 displays various screens, for example, a screen for guiding the battery stations and a screen for the battery exchange reservation. The operation device 62 accepts various screen operations on the screen displayed on the display 61. The display 61 and the operation device 62 may consist of a touch panel display that integrates a display panel as the display 61 and a touch panel as the operation device 62.

The communication device 63 communicates with the management server 4 via the network.

The storage device 64 stores programs and the like to be executed by the processor that constitutes the controller 65.

The controller 65 consists of a processor, and performs various processes relating to guidance on the battery stations and the battery exchange reservation. Namely, in response to the screen operations on the operation device 62 by the user and based on the information transmitted from the management server 4, the controller 65 controls the display 61 to display a screen for guiding the location and operation state of each battery station, a screen for the battery exchange reservation, and the like.

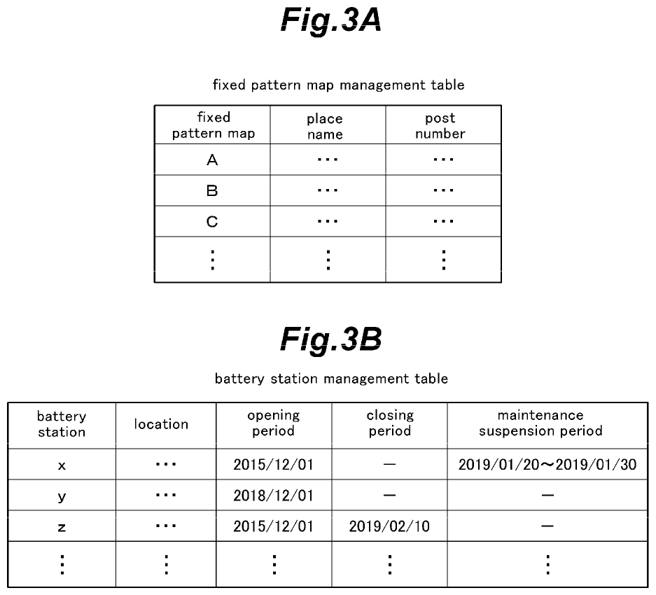

Next, a fixed pattern map management table and a battery station management table used by the management server 4 will be described. FIGS. 3A and 3B are explanatory diagrams showing registered contents of the fixed pattern map management table and the battery station management table.

In the management server 4, as shown in FIG. 3A, the fixed pattern map management table is stored in the storage device 42. In the fixed pattern map management table, a place name and a post number are registered for each fixed pattern map. By referring to the fixed pattern map management table, the management server 4 can identify the fixed pattern map including an area where the user requests the guidance based on the place name and the post number designated by the user.

Further, in the management server 4, as shown in FIG. 3B, the battery station management table is stored in the storage device 42. In the battery station management table, a location (latitude and longitude), an opening period (opening day), a closing period (closing day), and a maintenance suspension period are registered for each battery station. By referring to the battery station management table, the management server 4 can acquire information on the operation state of each battery station at a reference date and time (designated date and time) designated by the user. Also, based on the location of the battery station, the battery station on the fixed pattern map including the area where the user requests the guidance can be identified.

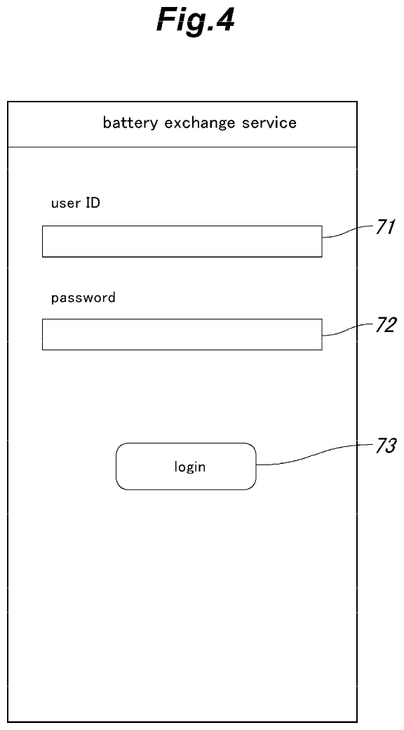

Next, a login screen displayed on each user terminal 5 will be described. FIG. 4 is an explanatory diagram showing the login screen.

The login screen is displayed on the user terminal 5 when the user terminal 5 accesses the management server 4. The login screen and its subsequent screens are displayed by an application (for example, a web browser) for station guidance installed on the user terminal 5.

This login screen shows an input section 71 for a user ID, an input section 72 for a password, and a login button 73. When each user inputs the user ID and the password and then operates the login button 73, the management server 4 performs the user authentication based on the input user ID and the password.

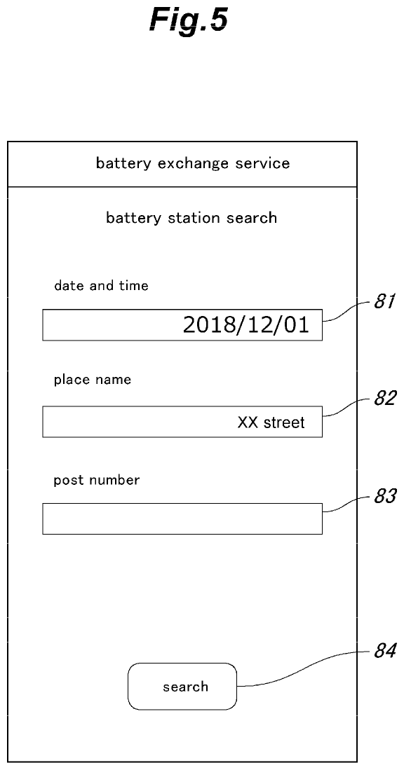

If the user authentication is successfully performed, the login screen transitions to a menu screen (not shown) in the user terminal 5. When an operation for selecting battery station guidance is performed on this menu screen, the menu screen transitions to a search screen (see FIG. 5).

Next, the search screen displayed on each user terminal 5 will be described. FIG. 5 is an explanatory diagram showing the search screen.

This search screen is displayed when the operation for selecting the battery station guidance on the menu screen (not shown) is performed.

This search screen shows a reference date and time input section 81, a place name input section 82, a post number input section 83, and a search button 84.

Into the reference date and time input section 81, the user can input the reference date and time as a search condition. The reference date and time may be selected on a calendar screen or the like. Further, the current date and time is displayed in an initial state, and the current date and time is set to the reference date and time if the user does not designate the reference date and time. Into the place name input section 82, the user can input the place name as the search condition. Further, each section in the service target area may be selected by using a pull-down menu or the like. Into the post number input section 83, the user can input the post number as the search condition.

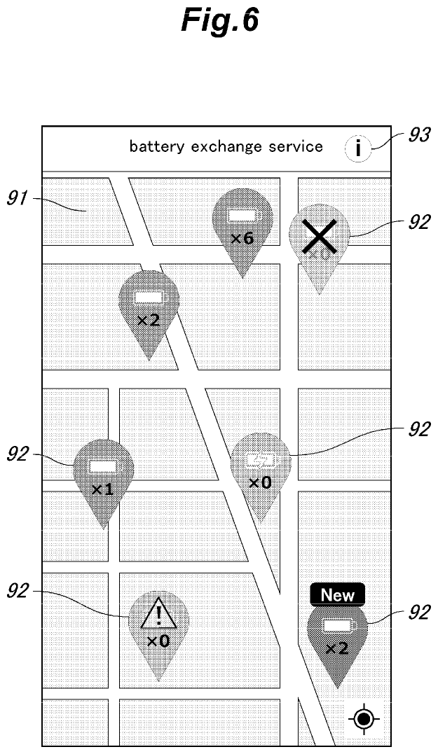

When the user inputs the search conditions (the reference date and time, the place name, and the post number) and operates the search button 84, a process of searching for the fixed pattern map and a process of acquiring battery station information are performed in the management server 4 based on the input search conditions. The fixed pattern map, location information on each battery station, and the operation state information on the battery station, which are acquired by these processes, are transmitted to each user terminal 5, and a station guidance screen (see FIG. 6) is displayed on the user terminal 5.

In the present embodiment, the fixed pattern map is narrowed down based on the place name and the post number, but the user may select a target area from an entire map of the service target area.

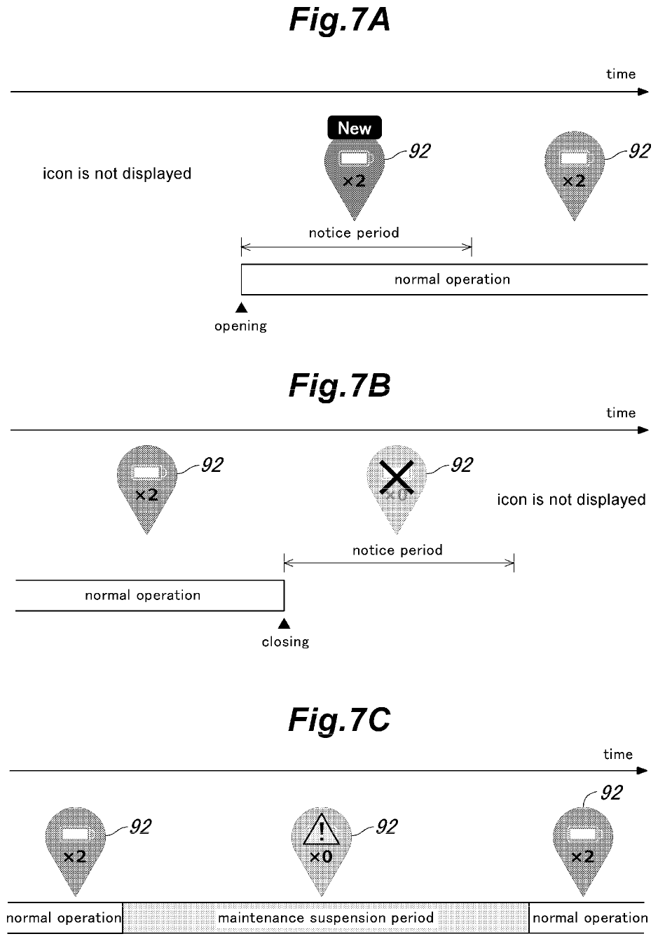

Next, the station guidance screen displayed on each user terminal 5 will be described. FIG. 6 is an explanatory diagram showing the station guidance screen. FIGS. 7A to 7C are explanatory diagrams each showing a transition state of each icon 92 of the battery station on the station guidance screen.

This station guidance screen is displayed when the search conditions (the reference date and time, the place name, and the post number) are input on the search screen (see FIG. 5) and the search button 84 is operated.

On this station guidance screen, a guide map in which the icons 92 (fixed pattern images) of the battery stations are superimposed on an area map 91 is shown. In each icon 92 of the battery station, the number of battery packs 2 that can be exchanged at the corresponding battery station, namely, the number of fully charged battery packs 2 that can be rented at the corresponding battery station is displayed.

In the present embodiment, the station guidance screen is displayed such that the current date and time is set to the reference date and time. Alternatively, any future date and time may be set to the reference date and time, and the station guidance screen at this reference date and time may be displayed. In such a case where the reference date and time is different from the current date and time, the number of battery packs 2 that can be exchanged at the battery station is not displayed. Further, in a case where the reference date and time is different from the current date and time, information such as an average number of users per day and a congestion level (high, normal, low) based on exchanging records of the battery packs 2 in a prescribed past period can be added, instead of displaying the number of battery packs 2 that can be exchanged.

The area map 91 is a fixed pattern map created in advance for each of the sub-areas included in the service target area, and is stored in the storage device 42. In the present embodiment, a fixed pattern map of an area corresponding to the place name and the post number as the search conditions is selected from a plurality of fixed pattern maps stored in the storage device 42. Incidentally, the management server 4 may acquire map information on an area from a map distribution system without storing information on the area map 91 (fixed pattern map). Further, the management server 4 may periodically update the fixed pattern map stored in the storage device 42 by using the map distribution system.

Further, when the icon 92 of each battery station is operated (for example, tapped) in this station guidance screen, detailed information (a location, a contact address, or the like) about the corresponding battery station is displayed.

Further, in this station guidance screen, the display mode of the icon 92 of each battery station changes depending on whether the user can exchange a required number of battery packs 2. More specifically, in a case where a battery pack 2 that can be rented is not present or in a case where the battery packs 2 are not suitable for the battery configuration of the user, the icon 92 is displayed in a color (for example, gray) that is different from a color (for example, blue) in a normal mode where the battery packs 2 can be exchanged.

Further, in this station guidance screen, the display mode of the icon 92 of each battery station changes according to the operation state of the battery station at the reference date and time designated by the user, more specifically, the opening, closing, and maintenance suspension of the battery station. This change guides the user through the opening, closing, and maintenance suspension of the battery station.

The example shown in FIG. 7A shows a case where a battery station is newly opened. In such a case, when the reference date and time enters a prescribed notice period (for example, one month) starting from the opening day, the icon 92 of the battery station is displayed in an opening notice mode. When the notice period ends, the display mode of the icon 92 transitions to the normal mode. Accordingly, the user can identify whether the opening period of the battery station is new or old.

In this opening notice mode, for example, characters (for example, “New”) indicating that the battery station has been newly opened are displayed on the icon 92. Further, in the opening notice mode, the icon 92 may be displayed in a color (for example, red) that is different from a color (for example, blue) of the icon 92 in the normal mode. Accordingly, the user can easily grasp that the battery station has been newly opened.

Incidentally, the icon 92 of the battery station is not displayed until the battery station is opened. Alternatively, the notice that the battery station will be newly opened may be given by displaying the icon 92 of the battery station with a changed display mode. Namely, the display mode of the icon 92 may be changed in a prescribed notice period (for example, one month) ending in the opening day to guide the user through the forthcoming opening of the battery station.

The example shown in FIG. 7B shows a case where a battery station is closed. In such a case, when the reference date and time enters a prescribed notice period (for example, one month) starting from the closing date, the display mode of the icon 92 of the battery station changes from the normal mode to a closing notice mode. After the notice period, the icon 92 is not displayed.

In this closing notice mode, for example, the icon 92 is displayed in gray. Further, a mark (for example, a cross mark) indicating that the user can no longer use the battery station is added to the icon 92. Accordingly, the user can immediately grasp that the battery station the user frequently uses has been closed.

Incidentally, the icon 92 of the battery station is displayed in the normal mode until the battery station is closed. Alternatively, the notice that the battery station will be closed may be given by displaying the icon 92 of the battery station with a changed display mode. Namely, the display mode of the icon 92 may be changed in a prescribed notice period (for example, one month) ending in the closing day to guide the user through the forthcoming closing of the battery station.

The example shown in FIG. 7C shows a case where the battery station is under maintenance suspension, namely, a case where the service of the battery station is suspended due to maintenance work (construction or inspection). In such a case, when the reference date and time enters a maintenance suspension period, the display mode of the icon 92 of the battery station changes from the normal mode to a maintenance notice mode. When the maintenance suspension period ends, the display mode of the icon 92 returns to the normal mode.

In this maintenance notice mode, a mark (for example, a mark symbolizing “under construction” or “caution”) indicating that the battery station cannot be used temporarily at the moment for maintenance work is added to the icon 92.

In the present embodiment, as examples of the change in the display mode of the icon 92 of the battery station, characters or graphic images are added to the icon 92 or the display color of the icon 92 is changed, but the change in the display mode of the icon 92 is not limited to these examples. For example, the type of the lines drawn on the icon 92 (thick lines, broken lines, or the like) may be changed, or a part or the entirety of the icon 92 may be blinked.

Further, in the present embodiment, the icon 92 of each battery station is generated based on the information on the number of battery packs 2 that can be exchanged at the battery station and the operation state (the opening, closing, or maintenance suspension) of the battery station, and the guide map in which the icon 92 is superimposed on the area map 91 (the fixed pattern map) is shown on the station guidance screen, but the guide map may be generated by either the management server 4 or each user terminal 5. In a case where the guide map is generated by the user terminal 5, necessary information (namely, information on the area map 91 (the fixed pattern map) and information on the number of battery packs 2 that can be exchanged at the battery station and the operation state (the opening, closing, or maintenance suspension) of the battery station) may be transmitted from the management server 4 to the user terminal 5.

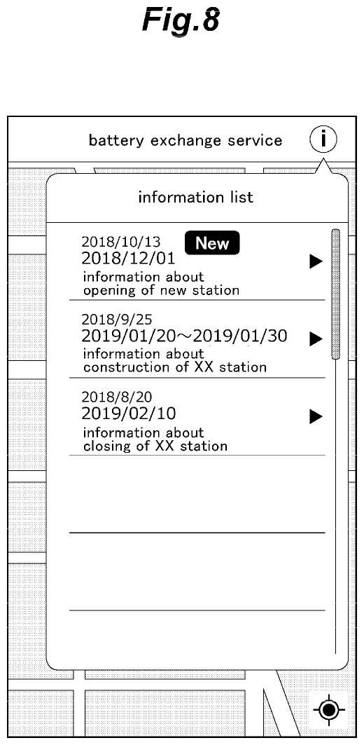

Further, as shown in FIG. 6, the station guidance screen shows an information button 93. When this information button 93 is operated, the station guidance screen transitions to a notification list screen (see FIG. 8).

Next, the notification list screen displayed on each user terminal 5 will be described. FIG. 8 is an explanatory diagram showing the notification list screen.

This notification list screen is displayed when the information button 93 is operated on the station guidance screen (see FIG. 6).

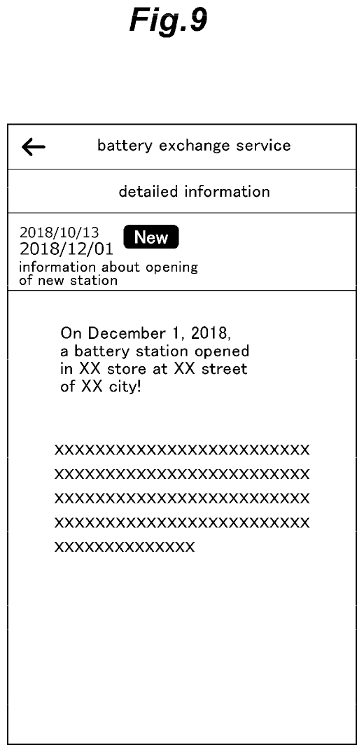

On this notification list screen, the digest information on each of the notification items is displayed on a list. When an operation for selecting any of the notification items is performed on the notification list screen, the notification list screen transitions to a detailed notification screen (see FIG. 9) relating to the selected notification item.

Next, the detailed notification screen displayed on the user terminal 5 will be described. FIG. 9 is an explanatory diagram showing the detailed notification screen.

This detailed notification screen is displayed when the operation for selecting any of the notification items is performed on the notification list screen (see FIG. 8).

On this detailed notification screen, the detailed information on the notification item selected on the notification list screen is displayed. In FIG. 9, a notification of the opening of the battery station is shown as an example, but a notification of the closing or maintenance suspension of the battery station is similar to the notification of the opening thereof. Namely, in a case of the closing of the battery station, the detailed information on the date and time of the closing and the guidance on an alternative battery station is displayed. In a case of the maintenance suspension, the detailed information on the contents of construction (for example, duration of construction) or the like is displayed.

Thus, in the present embodiment, the digest information on the battery station is displayed on the notification list screen (see FIG. 8), and the detailed information on the battery station is displayed on the detailed notification screen (see FIG. 9). Accordingly, the user can check the change in the operation state of the battery station. Further, the icon 92 whose display mode changes depending on the operation state of the battery station is displayed on the station guidance screen (see FIG. 6). Accordingly, the user can quickly confirm the operation state of the battery station without checking the notification list screen and the detailed notification screen.

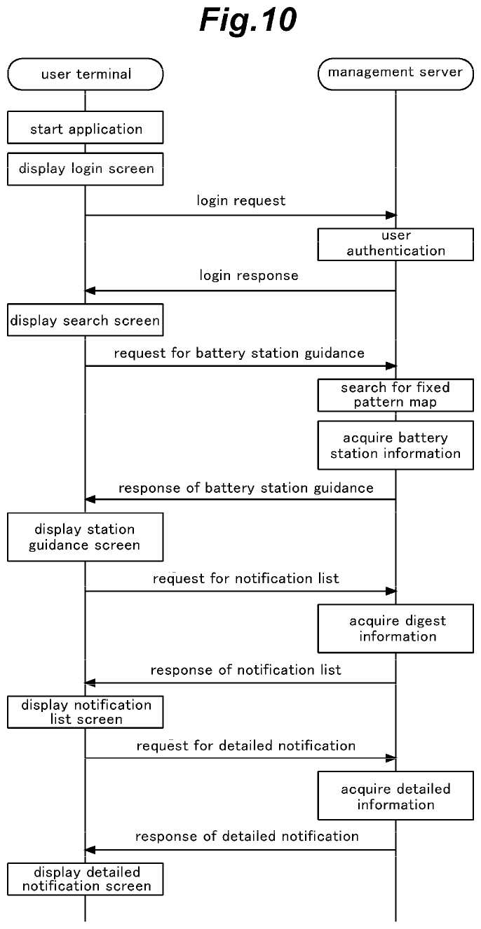

Next, operation procedures of the user terminal 5 and the management server 4 when the battery station information is provided will be described. FIG. 10 is a sequence diagram showing the operation procedures of the user terminal 5 and the management server 4 when the battery station information is provided.

First, upon starting an application for station guidance, the user terminal 5 displays the login screen (see FIG. 4). When the user performs a login operation on this login screen, the user terminal 5 transmits a login request to the management server 4.

Upon receiving the login request from the user terminal 5, the management server 4 performs the user authentication based on the user ID and the password included in the login request, and transmits a login response to the user terminal 5.

Upon receiving the login response from the management server 4, the user terminal 5 displays the menu screen (not shown) in a case where the user authentication is successfully performed and the login is approved. When the user selects the battery station guidance on this menu screen, the menu screen transitions to the search screen (see FIG. 5). When the user inputs the search conditions (the reference date and time, the place name, and the post number) and performs a search instruction operation on this search screen, the user terminal 5 transmits a request for the battery station guidance to the management server 4.

Upon receiving the request for the battery station guidance from the user terminal 5, the management server 4 searches for the fixed pattern map (map information) in the area (the designated area) desired by the user by referring to the fixed pattern map management table (see FIG. 3A) based on the search conditions (the place name and the post number) included in the request.

Upon finding the fixed pattern map that meets the search condition, the management server 4 acquires the location information and the operation state information (the opening period, the closing period, and the maintenance suspension period) about the battery station on the fixed pattern map by referring to the battery station management table (see FIG. 3B). At this time, the management server 4 acquires the operation state information on the battery station at the date and time (designated date and time) desired by the user based on the search condition (the reference date and time) included in the request.

Next, the management server 4 transmits a response of the battery station guidance to the user terminal 5. This response includes fixed pattern map information, the location information (latitude and longitude) and operation state information on the battery station, and information on the charging state of the battery packs 2 (the number of fully charged battery packs 2).

Upon receiving the response of the battery station guidance from the management server 4, the user terminal 5 displays the station guidance screen (see FIG. 6) based on the fixed pattern map information, the location information and operation state information on the battery station, and the information on the charging state of the battery packs 2 included in the response. At this time, the user terminal 5 generates the icon 92 of each battery station based on the operation state information on the battery station and the information on the charging state of the battery packs 2, and superimposes the icon 92 of the battery station on the area map 91 (the fixed pattern map) based on the location information on the battery station. When the user operates the information button 93 on the station guidance screen, the user terminal 5 transmits a request for a notification list to the management server 4.

Upon receiving the request for the notification list from the user terminal 5, the management server 4 transmits a response of the notification list, which includes the digest information on the battery station, to the user terminal 5.

Upon receiving the response of the notification list from the management server 4, the user terminal 5 displays the notification list screen (see FIG. 8) based on the digest information on the battery station included in the response. When the user performs the operation for selecting any of the notification items on the notification list screen, the user terminal 5 transmits a request for a detailed notification to the management server 4.

Upon receiving the request for the detailed notification from the user terminal 5, the management server 4 transmits a response of the detailed notification, which includes detailed information on the battery station relating to the notification item selected by the user, to the user terminal 5.

Upon receiving the response of the detailed notification from the management server 4, the user terminal 5 displays the detailed notification screen (see FIG. 9) based on the detailed information on the battery station included in the response.

The present invention has been described in terms of a specific embodiment, but is not limited by such an embodiment, and can be modified, substituted, added and omitted in other embodiments. Also, a new embodiment may be created by combining various components of the foregoing embodiment.

### INDUSTRIAL APPLICABILITY

The battery management system, the battery management method, and the terminal device according to the present invention have the effect of enabling a user to easily grasp an operation state of a battery station in an area desired by the user regardless of the current position of the user, are applicable to a battery exchange service which enables users of electric vehicles or the like to exchange battery devices at battery stations, and are useful as a battery management system and a battery management method for managing the battery stations and the battery devices, a terminal device carried by each user, or the like.

### REFERENCE NUMERALS

1: electric vehicle
2: battery pack
3: battery exchanger
4: management server
5: user terminal
6: management terminal
7: maintenance terminal
91: area map
92: icon (fixed pattern image)

1. A battery management system, comprising:
a plurality of battery exchange devices located in respective battery stations and configured to store and charge battery devices returned by users and to rent the charged battery devices to the users in exchange for the returned battery devices;
a server device connected to the battery exchange devices via a network and configured to manage exchanging states of the battery devices at the battery exchange devices; and
a terminal device carried by each user and connected to the server device via the network;
wherein the server device is configured to
acquire map information on a designated area according to an operation on the terminal device by the user,
acquire operation state information on an opening period of each battery station located in the designated area, and
display a guide map on the terminal device based on the map information and the operation state information, the guide map showing a fixed pattern image indicating a location of the battery station and superimposed on a map of the designated area such that whether the opening period of the battery station is new or old can be identified.

2. The battery management system according to claim 1, wherein the server device is configured to
store the operation state information on the respective battery stations, and
select the operation state information on the battery station located in the designated area based on location information on the respective battery stations.

3. The battery management system according to claim 1, wherein the server device is configured to
acquire information on a designated date and time according to the operation on the terminal device by the user, and
display the fixed pattern image in a display mode corresponding to an opening state of the battery station at the designated date and time.

4. The battery management system according to claim 3, wherein the server device is configured to change the display mode of the fixed pattern image in a case where a difference between the opening period of the battery station and the designated date and time is within a prescribed period.

5. The battery management system according to claim 4, wherein a change in the display mode of the fixed pattern image includes at least one of a change in a display color of the fixed pattern image, blinking of a part or an entirety of the fixed pattern image, addition of characters to the fixed pattern image, and addition of a graphic image to the fixed pattern image.

6. A battery management method used by a server device for managing battery stations where users exchange battery devices and for managing the battery devices, the battery management method comprising:
acquiring map information on a designated area according to an operation on a terminal device carried by each user,
acquiring operation state information on an opening period of each battery station located in the designated area, and
displaying a guide map on the terminal device based on the map information and the operation state information, the guide map showing a fixed pattern image indicating a location of the battery station and superimposed on a map of the designated area such that whether the opening period of the battery station is new or old can be identified.

7. A terminal device carried by a user and connected to a server device via a network,
wherein the terminal device is configured to display a guidance screen for guiding a location of a battery station to the user based on information transmitted from the server device, and
the guidance screen includes a guide map showing a fixed pattern image indicating a location of the battery station and superimposed on a map of a designated area designated by the user such that whether an opening period of the battery station is new or old can be identified.
